(19) United States
(12) Patent Application Publication
(10) Pub. No.: US 2004/0034501 A1
(43) Pub. Date: Feb. 19, 2004

(54) Method and apparatus for determining the eccentricity of a hollow billet

(75) Inventors: Martin Sauerland, Monchengladbach (DE); Karl Heinz Hausler, Korschenbroich (DE)

Correspondence Address: THE FIRM OF KARL F ROSS, 5676 RIVERDALE AVENUE, PO BOX 900, RIVERDALE (BRONX), NY, 10471-0900, US

(73) Assignee: SMS Meer GmbH

(21) Appl. No.: 10/611,654

(22) Filed: Jul. 1, 2003

(30) Foreign Application Priority Data
Jul. 3, 2002 (DE) 10229771.1

(51) Int. Cl. G06F 15/00

(52) U.S. Cl. 702/170

(57) ABSTRACT

A method of determining eccentricity of a hollow billet in the course of rolling in seamless tubing or seamless pipe manufacture whereby at the outlet side of an inclined roll mill at least one measurement head is provided for ultrasonic wall thickness measurement and the results of a number of measurements are processed by Fast Fourier Transform analysis series elements which approximate the eccentricity as a result of the helical or spiral superimposition of an eccentricity amplitude on the mean eccentricity in terms of the wall thickness of the hollow billet.

### FIELD OF THE INVENTION

The present invention relates to a method of and to an apparatus for determining the eccentricity of a hollow billet, preferably at the inlet to a rolling line and between that rolling line and an inclined-roll mill. The invention especially relates to a method and apparatus for determining such eccentricity downstream of an inclined-roll mill and especially immediately upstream of a conti-rolling line (i.e. a continuous seamless tube or pipe rolling line) or a billet-pusher or pusher bench rolling line.

In such systems the hollow billet enters the rolling line by movement in a direction along the longitudinal axis of the hollow billet and the eccentricity can be determined with at least one measuring device which can determine the wall thickness of the hollow billet at a longitudinal position and a circumferential position of the hollow billet.

### BACKGROUND OF THE INVENTION

Seamless pipe or tubing of steel is required for many fields of use and, as a general matter, seamless pipe or tubing can be produced utilizing a cylindrical billet or bloom as a starting material and passing that billet or bloom through an inclined-roll mill in conjunction with the use of an axially stationary piercing mandrel to produce a hollow billet which can then be subjected to rolling to form the seamless tubing or pipe. The inclined roll mill initially at least rolls the billet over the piercing mandrel. Subsequent rolling can be effected to the desired dimension of the seamless tubing or pipe without a mandrel. A process of this type is described, for example, in EP 0 940 193 A2. In the subsequent stretch-reducing rolling in reducing roll mills and dimensioning or sizing roll mills, the seamless steel pipe is formed in a rolling line in which, in the direction of advance of the pipe, a number of mill stands are provided. The mill stands are provided with rolls, frequently grooved rolls, which contact defined segments of the periphery of the seamless pipe. The multiplicity of rolls cooperate so that there is ultimate contact with the pipe over its entire periphery, the pipe diameter is reduced, the pipe is elongated during the reduction in diameter and a seamless pipe or tubing with a precise shape is formed.

The pipe should have an ideal shape after this rolling, i.e. the inner contour and the outer contour should be perfectly cylindrical and the two cylindrical contours should be as precisely coaxial as possible so that in any cross section through the seamless pipe or tube, the inner and outer peripheries should define perfectly concentric circl s.

In practice, however, the finished pipe or tube always has certain tolerances with respect to the concentricity of these circles and thus a certain eccentricity between inner and outer circular contours is acceptable and even unavoidable. However this eccentricity is an important quality parameter of the seamless pipe fabrication method and apparatus. To monitor this quality parameter, a wall thickness of the seamless pipe is measured. The determination of the wall thickness of the pipe by ultrasonic measurement process is known. The ultrasonic thickness measurement can utilize a pulse echo method in which the transit time for an ultrasonic pulse to travel across the wall thickness is determined.

In addition to the wall thickness a very important parameter of the pipe and an additional quality criterium of the hollow billet and the various stages of the pipe during rolling is the eccentricity of the hollow billet.

The wall thickness measuring device at the discharge side of an inclined roll mill can provide wall thickness measurements from which an indication of the eccentricity can be obtained. However, a problem with previous measurements is that at the outlet side of the inclined roll mill the hollow billet rotates. As a result, the wall thickness measuring device can take a number of wall thickness measurements over the periphery of the hollow billet from which the eccentricity can be determined.

The eccentricity as thus determined, however, cannot provide a good indication of the course of the eccentricity over the length of the hollow billet or seamless pipe since the eccentricity tends to meander in the direction of the longitudinal coordinate and to have a helical pattern. The helical pattern of the eccentricity appears to be a function of the rolling process in the inclined roll mill and to have a corkscrew character. The eccentricity thus follows a main internal screw pattern of the inner periphery with a pitch or per-turn length as a function of the angle of advance of the inclined roll mill. Other eccentricity properties and characteristics of greater pitch or lower frequency are superimposed on the main eccentricity pattern and can be produced, for example, by nonuniform heating of the hollow billet in a rotary hearth furnace.

The measurement of the course of the eccentricity over the longitudinal coordinate of the hollow billet and thus the determination of the position of the inner surface relative to the outer surface along the longitudinal coordinate of the hollow billet creates problems when the measurement must be made at the outlet side of an inclined-roll mill.

Firstly, in such an application there is very little space even for a single measuring device and thus a measuring device, if provided, can occupy only limited space. Secondly it is not possible to acquire information over the full length of the hollow billet even under the conditions that the latter is rotating. The eccentricity at the ends of the hollow billets are of particular significance for rolling operations and it is precisely at the ends of the hollow billet that it is most difficult to measure the eccentricity.

Efforts to overcome these drawbacks with complicated measuring devices, multiple measuring devices, increased lengths for the measurement, measurement manipulators and even separate conveyors along which the hollow billet may be displaced have proved to be disadvantageous because of the high cost and greater complexity of such systems and the inability to retrofit existing rolling lines with such devices.

The problem is particularly pronounced when the measurement of the eccentricity must be taken upstream of a conti-rolling line or a pusher-type rolling system.

### OBJECTS OF THE INVENTION

It is, therefore, the principal object of the present invention to provide an improved method of determining the eccentricity of a hollow billet in the course of rolling, whereby these drawbacks can be avoided.

More particularly, it is an object of the invention to provide an improved method of determining the eccentricity of a hollow billet which can more effectively determine eccentricity even at the ends of the hollow billets, especially as a quality measurement or seamless tubing or seamless pipe, without increasing the cost and whereby existing rolling lines can be retrofitted for such measurements.

It is also an object of the invention to provide an improved apparatus for determining eccentricity.

### SUMMARY OF THE INVENTION

A method of determining the eccentricity (e) of a hollow billet in the course of rolling, preferably upstream of a rolling mill line following an inclined roll mill and thus downstream or at the outlet side of an inclined-roll mill and especially at the upstream side of a conti-rolling line or a press bench rolling line, in which the hollow billet is fed in the direction of the longitudinal axis of the hollow billet and at least one measuring device is provided to detect a wall thickness (s) of the hollow billet at position (d) along its length and at an angular position (φ) or a position along its circumference, approximate the course of the eccentricity as a course of the wall thickness in accordance with the relationship

e∝s(φ,z)=s₀(z)+s₁(z)cos(φ+δ(z)).

In this relationship s₀ is the mean wall thickness of the hollow billet, s₁ is the wall thickness amplitude superimposed on the mean wall thickness s₀ and δ is the angular position of a function of the longitudinal coordinate (z).

According to the invention, the measuring device takes a number of measurements and the measurements are subjected to a Fourier transformation as will be detailed below utilizing the computer programmed for Fourier transformation and connected to the measuring unit.

More particularly, the method of the invention comprises the steps of:

(a) advancing the hollow billet in a direction along a longitudinal axis (L) of the hollow billet past at least one measuring device provided to detect the wall thickness (s) of the hollow billet at a position (z) along its length and at an angular position (φ) thereof or a position along its circumference;

(b) approximating a course of the eccentricity (e) of the hollow billet by the course of the wall thickness (s) as a function of the longitudinal coordinate (z) extending along the longitudinal axis (L) of the hollow billet and the angle (φ) about the longitudinal axis in accordance with the relationship:

s(φ,z)=s₀(z)+s₁(z)cos(φ+δ(z))

where s₀ is the mean wall thickness of the hollow billet, s₁ is the wall thickness amplitude superimposed on the mean wall thickness and δ is the angular position as a function of the longitudinal coordinate (z); and

(c) upon passage of the hollow billet past the measuring device taking a number of wall thickness measurements, feeding the measured values to a computer, and subjecting the measured values in the computer based upon the approximation to a Fourier transformation to obtain a functional course of the wall thickness (s) as a function of the longitudinal coordinate (z) and the angle (φ) of the form:

s(φ,z)≅s₀* +Σs_{i,1} cos(φ+2πpᵢz+ξ_{i,1})

where s₀* and s_{i,1} are determined Fourier coefficients for the wall thickness of the hollow billet upon summation (i) over the number (n) of Fourier series elements and whereby pᵢ and ξ_{i,1} are the Fourier coefficients for a pitch of the course of eccentricity and for the starting angular position of the measurements upon summation (i) over the number (n) of Fourier series elements.

Preferably the hollow billet is not rotated during the measurement about its longitudinal axis. Of course more than one measurement unit can be used for the measurement. The wall thickness can be measured, according to the invention, using a laser ultrasonic wall thickness measuring device although a piercing mandrel can carry the measurement device or part of the measuring device and can lie within the hollow billet for the measurement. In the latter case the invention has considerable flexibility.

The apparatus for determining the eccentricity of the hollow billet has, as noted, a measuring device by means of which the wall thickness of the hollow billet can be determined at a position along its length and periphery. According to the invention, the at least one measuring device is designed for carrying out a number of wall thickness measurements as the hollow billet passes it and a computer is connected to the measuring device or devices for carrying out the Fourier transformation upon the measured wall thickness data to provide the approximation of the functional course of the wall thickness as a function of the longitudinal coordinate and angle around the axis of the hollow billet.

The measuring device is preferably located at the outlet of a rolling mill, especially an inclined-roll mill.

The wall thickness measuring device can utilize ultrasonic wall thickness measuring principles whereby a unit is provided for launching an ultrasonic signal into the hollow billet at the surface thereof. The means for launching the ultrasonic signal can include a laser trained on the surface of the hollow billet and especially a flash lamp pumped Nd:YAG laser. The ultrasonic wall thickness measuring unit can also include a means for determining a time interval between two echo ultrasonic signals or between the launched signal and the echo to enable the wall thickness to be calculated. The latter means can include a laser, for example, a diode pumped Nd:YAG laser and an optical analyzer, especially a Fabry-Perot interferometer.

With the system of the invention it is possible to determine the eccentricity of a hollow billet in a simple manner and thereby obtain a rapid and reliable indication of the quality of the hollow billet. Since the invention enables also the depiction of the spatial course of the eccentricity as a function of the longitudinal coordinate over the entire length of the hollow billet, the results can be used for controlling the manufacturing process as well as a determination of criteria for the quality of a hollow billet which can be readily evaluated.

### BRIEF DESCRIPTION OF THE DRAWING

The above and other objects, features, and advantages will become more readily apparent from the following description, reference being made to the accompanying drawing in which:

FIG. 1 is a diagrammatic perspective view illustrating a system for measuring the eccentricity of a hollow billet;

FIG. 2 is a diagram illustrating the measurement principles ; and

FIG. 3 is a perspective view showing the wall thickness measuring device in part on a piercing mandrel.

### SPECIFIC DESCRIPTION

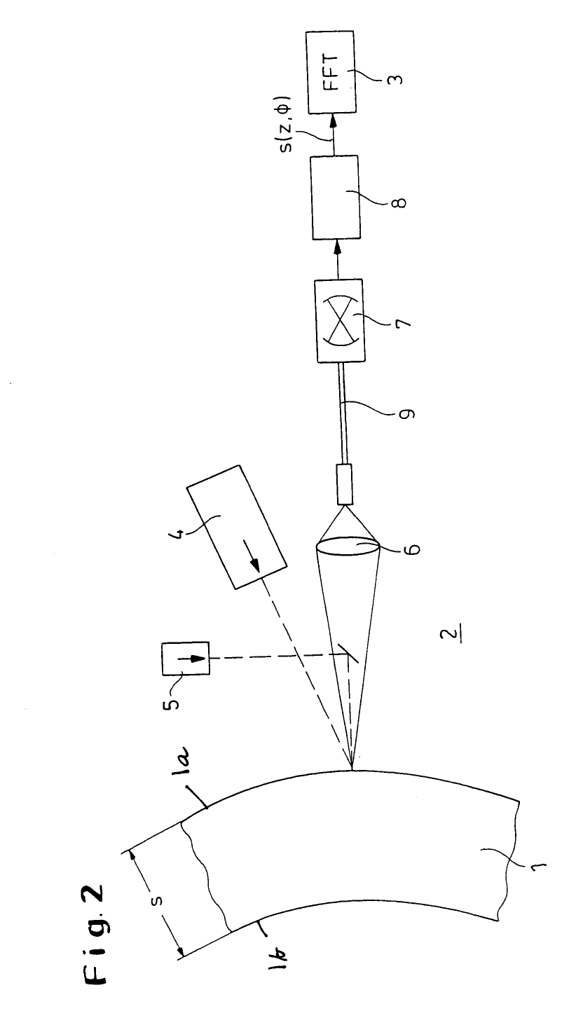

Referring first to FIG. 2 which illustrates the principle of wall thickness measurements which is utilized in the invention, we have shown a hollow billet 1 with a cylindrical outer periphery 1a and a cylindrical inner periphery 1b which should be, to the greatest extent possible, precisely coaxial with the outer periphery. That of course would lead to a constant value of the wall thickness s around the entire circumference of the hollow billet and throughout the length thereof. However, in practice, the wall thickness s will vary around the periphery and along the length of the hollow billet as a result of an eccentricity between the inner and outer peripheries. To measure the instantaneous wall thickness, an ultrasonic measurement is made of the wall thickness. An ultrasonic signal is launched into the thickness of the hollow billet and that signal traverses the thickness of the hollow billet and is reflected back by the inner periphery 1b so that the measurement of the time interval between launching the signal and receipt of the echo is twice the transmit time of the signal. From the known speed of sound in the material of the hollow billet and half the transit time for the ultrasonic pulse the wall thickness s is given.

Since the hollow billet may be at a temperature of about 1000° C., a contactless method is required for launching the ultrasonic signal into the hollow billet and for detecting the echo. The ultrasonic signal is applied to the hollow billet by directing a laser beam 4 against the surface of the hollow billet. The high energy light pulse in the infrared range is generated by a flash lamp pumped Nd:YAG laser and can explosively vaporize a surface portion of the hollow billet. The laser beam may have a wavelength of 1064 nm and a pulse duration of less than 10 ns. The explosive vaporization generates a vaporization pulse which as an ultrasonic pulse travels perpendicularly to the surfaces of the hollow billet across the wall thickness and is reflected back from the inner periphery. The result is the appearance at the outer periphery of the hollow billet of an ultrasonic echo pulse sequence of decreasing amplitude.

The reflected ultrasonic pulse is optically detected by detecting the effect of the echo pulse at the surface on another laser beam provided by a second laser, in this case an illumination or detection laser 5. This laser 5 can be a continuous wave or CW laser, for example a frequency-doubled diode pumped Nd:YAD laser operating at a wavelength of 532 nm and trained on the point on the surface which receives the excitation from the excitation laser 4. The vibrations at the surface 1a caused by the echo pulse give rise to a frequency modulation laser light reflected from the surface 1a.

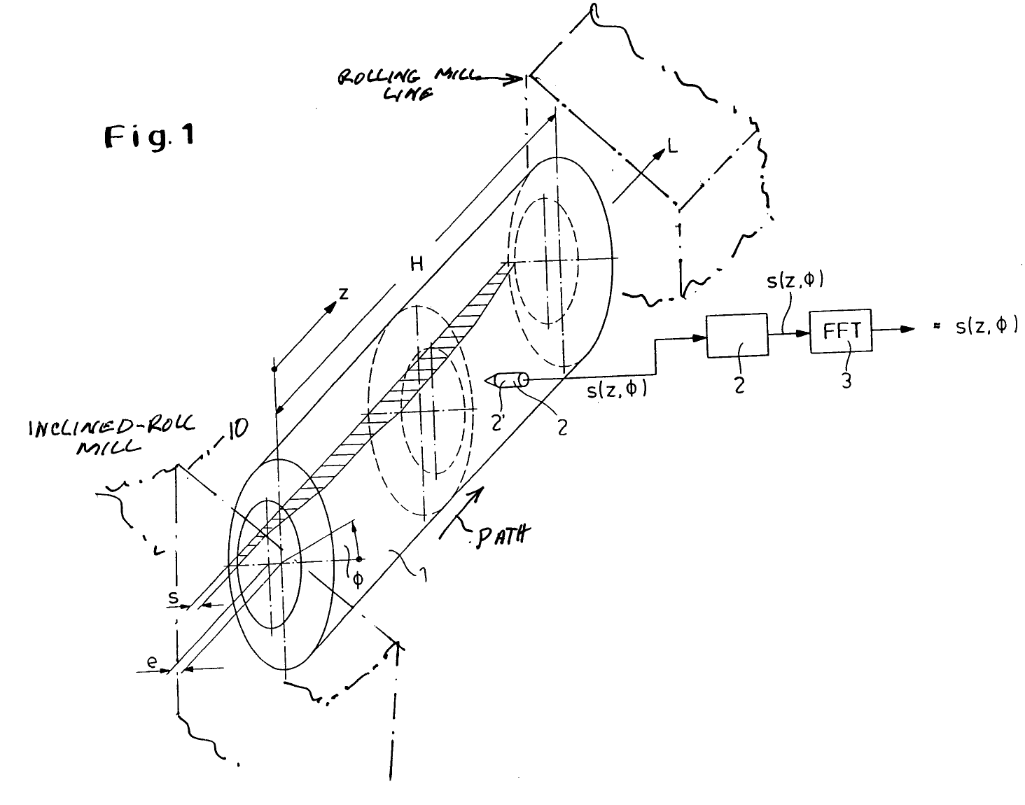

In FIG. 2 the reflected light cone forming the carrier of the ultrasonic signal is collected by a light amplifier collector optical system represented at 6 and forming part of the measuring head 2′ of FIG. 1 and containing the optics 2 as illustrated in FIG. 2.

The light waveguide 9, e.g. an optical fiber, picks up the amplified modulated light signal and supplies it to an optical analyzer which is a demodulator and can be a confocal Fabry-Perot interferometer. The output signal corresponds to the ultrasonic echo sequence.

Further amplification, filtering and signal evaluation of the ultrasonic echo sequence can be effected by an ultrasonic evaluated circuit or computer 8. The output signal from the computer 8 gives the wall thickness s calculated from the speed of sound in the hollow billet and the measured time interval. That signal is applied to the fast Fourier transform analyzer for computer 3.

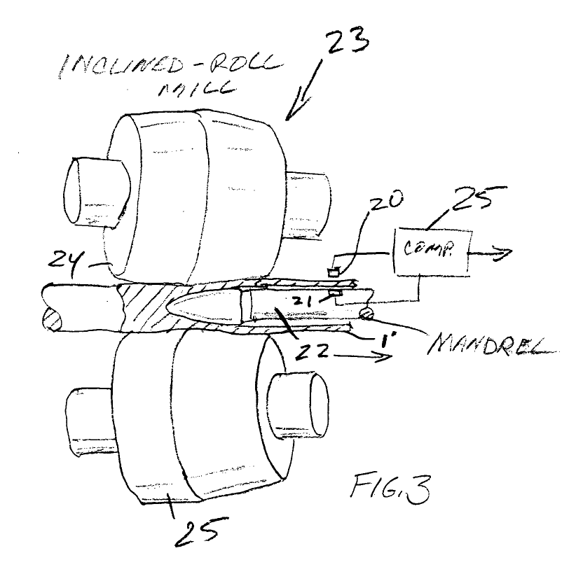

In FIG. 3, the thickness of the hollow billet 1′ is determined by sensors 20 and 21, at least one of which is provided on a piercing mandrel 22 of an inclined roll mill 23 whose rolls are shown at 24 and 25. The transit time information is supplied to the computer 25. Both in the embodiment of FIG. 2 and embodiment of FIG. 3, the detector in the wall thickness is provided downstream of an inclined roll mill and upstream of the rolling mill line, e.g. a conti-line or a pusher line as has been mentioned previously.

FIG. 1 shows how the eccentricity e of the hollow billet 1 is detected over the course of the longitudinal coordinate z of the hollow billet 1. Because of the rolling process in the inclined roll mill 10, the eccentricity e has a corkscrew-like or helical pattern along the longitudinal coordinate z of the hollow billet 1. In FIG. 3 three cuts are shown schematically to demonstrate the change in the narrow wall thickness region along the length z of the hollow billet 1. The wall thickness varies with the periodicity of the turn length of the helix and in FIG. 1 one full period has been represented at H.

To detect the eccentricity e as a function of the longitudinal coordinate z and the angle φ about the longitudinal axis of the hollow billet, a number of wall thickness measurements are taken with the hollow billet 1 moving relative to the measurement device 2 or its measurement head 2′ so that the wall thickness s is determined and stored in a computer 3.

For calculating the eccentricity the following approximation is used:

s(φ,z)=s₀(z)+s₁(z)cos(φ+δ(z))

wherein:

s₀ is the mean wall thickness of the hollow billet 1,

s₁ is the thickness amplitude superimposed upon the mean wall thickness s₀ and

δ is an angular position which is a function of the longitudinal coordinate z.

The measurement is also based upon the fact that the eccentricity periodically repeats with a pitch or turn length H.

The measured wall thickness is supplied to the computer 3 which subjects the data to Fourier transformation in which the functional course of the wall thickness is obtained as a function of the longitudinal coordinate z and the angle φ by an approximation of the form

s(φ,z)≅s₀*+Σs_{i,l} cos(φ+2πpᵢz+ξ_{i,1})

In this relationship:

s₀* and s_{i,1} represent the Fourier coefficients obtained for the wall thickness of the hollow billet 1 by a summation (i) over the number (n) of the Fourier coefficients for the pitch or starting angle for the summation (i) over the number (n) of the Fourier series element and

pᵢ and ξ_{i,1} are Fourier coefficients for the pitch or for the starting position angle upon summation (i) over the number (n) of the Fourier series element.

By means of the Fourier analysis, the Fourier coefficients are determined and represent the course of the eccentricity of the hollow billet as the superposition of harmonic oscillations of different amplitudes and different starting position angles.

The Fast Fourier Transformation represented at FFT in FIG. 3 is a conventional mathematical analytic process and is described, for example in “Hütte-Die Grundlagen der Ingenieurwissenschaften”, Volume 29, S.B. 34 ff. (See also pages A-35 through A-38 of Handbook of Telemetry and Remote Control, McGraw Hill Book Co. 1967).

In the above-mentioned approximation, the wall thickness s is an indication of the eccentricity as a function of the longitudinal coordinate z and is described in terms of an eccentricity amplitude s₁(z) and is associated with a cosine function which represents the helical pattern and is conditioned by an eccentricity angle (δ). From a mathematical viewpoint, the eccentricity is represented by a mean value on which the oscillation is superimposed. For a given angle φ, there is a conventional Fourier series in “z”. The starting position angle ξ_{i,1} represents the oscillation which is superimposed upon the mean value at the starting position. As a consequence, the overall course of the eccentricity over the length of the hollow billet is represented by the relationship given above summing the eccentricities over cosine of the angular positions.

The wall thickness evaluation of the measured values is thus interpreted by known interpretation and evaluation processes common in communication techniques for frequency shifts and modulation of the mean eccentricity value. The method can be modified in that other ultrasonic techniques can be used to determine the wall thickness and the system need not be a single channel system but can be a multi-channel system utilizing wall thickness measurements spaced equidistantly along the length of the hollow billet. It is, of course, important for a satisfactory determination of the eccentricity as a function of the longitudinal coordinate z and the angle φ that the scanning frequency be sufficient to provide a measurement which is as precise as it is desired. The minimum scanning frequency can be determined by the Shannon scanning theorem (see for example “Hütte-Die Grundlagen der Ingenieurwissenschaften”, Volume 29, S.B. 34 ff. (See also pages A-35 through A-38 of Handbook of Telemetry and Remote Control, McGraw Hill Book Co. 1967).

For example, a scanning rate of 50 Hz can detect a helix with a pitch of 40 mm with a sufficient precision when a hollow billet is displaced at a speed less than 1 m/s without rotation past the measuring head. The measurement in accordance with the invention is of special advantage for the detection of helical patterns of eccentricity in hollow billets both as a result of the development of a helical pattern in the inner or outer surfaces.

We claim:

1. A method of determining eccentricity (e) of a hollow billet in the course of rolling, comprising the steps of:
(a) advancing the hollow billet in a direction along a longitudinal axis (L) of the hollow billet past at least one measuring device provided to detect the wall thickness (s) of the hollow billet at a position (z) along its length and at an angular position (φ) thereof or a position along its circumference;
(b) approximating a course of the eccentricity (e) of the hollow billet by the course of the wall thickness (s) as a function of the longitudinal coordinate (z) extending along the longitudinal axis (L) of the hollow billet and the angle (φ) about the longitudinal axis in accordance with the relationship:
e∝s(φ,z)=s₀(z)+s₁(z)cos(φ+δ(z))
where s₀ is the mean wall thickness of the hollow billet, s₁ is the wall thickness amplitude superimposed on the mean wall thickness and δ is the angular position as a function of the longitudinal coordinate (z); and
(c) upon passage of the hollow billet past said measuring device taking a number of wall thickness measurements, feeding the measured values to a computer, and subjecting the measured values in said computer based upon said approximation to a Fourier transformation to obtain a functional course of the wall thickness (s) as a function of the longitudinal coordinate (z) and the angle (φ) of the form:
s(φ,z)=s₀*+Σs_{i,1} cos(φ+2πpᵢz+ξ_{i,1})
where s₀* and s_{i,1} are determined Fourier coefficients for the wall thickness of the hollow billet upon summation (i) over the number (n) of Fourier series elements and whereby pᵢ and ξ_{i,1} are the Fourier coefficients for a pitch of the course of eccentricity and for the starting angular position of the measurements upon summation (i) over the number (n) of Fourier series elements.

2. The method defined in claim 1 wherein the measurements are taken upstream of a rolling mill following an inclined-roll mill.

3. The method defined in claim 2 wherein the measurements are taken at an upstream side of a conti-rolling line.

4. The method defined in claim 2 wherein the measurements are taken at an upstream side of a press-bench rolling line.

5. The method defined in claim 2 wherein the hollow billet is maintained against rotation about said longitudinal axis (L) during taking of the measurements.

6. The method defined in claim 2 wherein the wall thickness of the hollow billet is measured by a laser ultrasound process.

7. The method defined in claim 2 wherein the wall thickness is measured by a tool inserted into said hollow billet.

8. The method defined in claim 7 wherein said tool is a mandrel.

9. An apparatus for determining eccentricity (e) of a hollow billet in the course of rolling, comprising:
a path over which a hollow billet is advanced in a direction along a longitudinal axis (L) of the hollow billet;
at least one measuring device provided along said path to detect the wall thickness (s) of the hollow billet at a position (z) along its length and at an angular position (φ) thereof or a position along its circumference whereby a course of the eccentricity (e) of the hollow billet can be approximated by the course of the wall thickness (s) as a function of the longitudinal coordinate (z) extending along the longitudinal axis (L) of the hollow billet and the angle (φ) about the longitudinal axis in accordance with the relationship:
e∝s(φ,z)=s₀(z)+s₁(z)cos(φ+δ(z))
where s₀ is the mean wall thickness of the hollow billet, s₁ is the wall thickness amplitude superimposed on the mean wall thickness and δ is the angular position as a function of the longitudinal coordinate (z); and
a computer connected with said at least one measuring device and receiving a number of wall thickness measurements upon passage of the hollow billet past said measuring device , said computer being programmed to subjecting the measured values based upon said approximation to a Fourier transformation to obtain a functional course of the wall thickness (s) as a function of the longitudinal coordinate (z) and the angle (φ) of the form:
s(φ,z)≅s₀*+Σs_{i,1} cos(φ+2πpᵢz+ξ_{i,1})
where s₀* and s_{i,1} are determined Fourier coefficients for the wall thickness of the hollow billet upon summation (i) over the number (n) of Fourier series elements and whereby pᵢ and ξ_{i,1} are the Fourier coefficients for a pitch of the course of eccentricity and for the starting angular position of the measurements upon summation (i) over the number (n) of Fourier series elements.

10. The apparatus defined in claim 9 wherein said at least one measuring device is located at an outlet of a rolling mill.

11. The apparatus defined in claim 10 wherein said rolling mill is an inclined-roll mill.

12. The apparatus defined in claim 9 wherein said at least one measuring device includes an ultrasonic wall thickness measurement unit having a device for launching an ultrasonic signal into a surface of said hollow billet.

13. The apparatus defined in claim 12 wherein said ultrasonic wall thickness measurement unit includes a device for measuring a time interval between two ultrasonic signals including an echo signal produced by launching an ultrasonic signal into said surface.

14. The apparatus defined in claim 13 wherein said ultrasonic wall thickness measurement unit includes a laser and an optical analyzer.

15. The apparatus defined in claim 14 wherein said laser is an Nd:YAG laser.

16. The apparatus defined in claim 13 wherein said optical analyzer is a Fabry-Perot interferometer.

17. The apparatus defined in claim 9 wherein the measurements are taken upstream of a rolling mill following an inclined-roll mill.

18. The apparatus defined in claim 17 wherein the measurements are taken at an upstream side of a conti-rolling line.

19. The apparatus defined in claim 17 wherein the measurements are taken at an upstream side of a press-bench rolling line.
